(19) United States
(12) Patent Application Publication
(10) Pub. No.: US 2022/0377186 A1
(43) Pub. Date: Nov. 24, 2022

(54) IMAGE PROCESSING DEVICE, CONTROL METHOD, AND NON-TRANSITORY COMPUTER READABLE MEDIUM

(71) Applicant: SHARP KABUSHIKI KAISHA, Sakai City (JP)

(72) Inventor: SHO TSUJIMOTO, Sakai City (JP)

(21) Appl. No.: 17/744,194

(22) Filed: May 13, 2022

(30) Foreign Application Priority Data
May 20, 2021 (JP) 2021-085458

(51) Int. Cl. H04N 1/00

(52) U.S. Cl. CPC H04N 1/00336; H04N 1/00236; H04N 1/00395; H04N 1/0044

(57) ABSTRACT

An image processing device includes an image inputter, a selector and a generator. The image inputter inputs an image. The selector selects a setting of a layout. The generator, based on the setting of the layout, generates, from the image, a document file having information about the layout.

### CROSS-REFERENCE TO RELATED APPLICATION

The present application claims priority from Japanese Patent Application Number 2021-085458, the content to which is hereby incorporated by reference into this application.

### BACKGROUND OF THE INVENTION

### 1. Field of the Invention

The present disclosure relates to an image processing device or the like.

### 2. Description of the Related Art

There has been proposed a known technology that generates a predetermined-format file from a manuscript read by a scanner or the like. For example, there has been proposed a technology that, in an image reading device, generates a file in the form of being pasted on a single sheet or a plurality of sheets, with a plurality of manuscript images read by a reader as an Excel (registered trademark) data (e.g., Japanese Unexamined

### SUMMARY OF THE INVENTION

However, the technology described in Japanese Unexamined Patent Application Publication No. 2012-146102 generates the file that accords to a predetermined placing method, such as pasting the manuscript image as is directly to the sheet, thus leaving a problem of failing to generate a file that is subjected to the placing method intended by a user.

In view of the above problem, it is an object of the present disclosure to provide an image processing device or the like that selects a layout setting and generates a document file that is based on the above setting.

For solving the above problem, an image processing device according to the present disclosure includes: an image inputter that inputs an image; a selector that selects a setting of a layout; and a generator that, based on the setting of the layout, generates, from the image, a document file having information about the layout.

An image processing method according to the present disclosure includes: inputting an image; selecting a setting of a layout; and based on the setting of the layout, generating, from the image, a document file having information about the layout.

A non-transitory computer readable medium according to the present disclosure records a program to cause a computer to realize functions that includes: inputting an image; selecting a setting of a layout; and based on the setting of the layout, generating, from the image, a document file having information about the layout.

According to the present disclosure, it is possible to provide an image processing device or the like that selects a layout setting and generates a document file that is based on the above setting.

### BRIEF DESCRIPTION OF THE DRAWINGS

FIG. 1 is an external perspective view of an image forming device in a first embodiment.

FIG. 2 describes a functional configuration of the image forming device in the first embodiment.

FIG. 3 is a flowchart for describing the main process flow in the first embodiment.

FIG. 4 is a flowchart for describing the flow of a first generating method in the first embodiment.

FIG. 5 is a flowchart for describing the flow of a second generating process in the first embodiment.

FIG. 6A, FIG. 6B and FIG. 6C each show an operation example (format selection screen) in the first embodiment.

FIG. 7 shows an example of a manuscript that is input to the image forming device.

FIG. 8 shows an operation example in the first embodiment.

FIG. 9 shows the operation example in the first embodiment.

FIG. 10 shows the operation example in the first embodiment.

FIG. 11 shows the operation example in the first embodiment.

FIG. 12 shows the operation example in the first embodiment.

FIG. 13 shows the operation example in the first embodiment.

FIG. 14A and FIG. 14B each show the operation example in the first embodiment.

FIG. 15A and FIG. 15B each show an operation example (format selection screen) in a second embodiment.

FIG. 16 is a flowchart for describing the flow of the main process in a third embodiment.

FIG. 17 shows an operation example in the third embodiment.

### DETAILED DESCRIPTION OF THE INVENTION

Hereinafter, an embodiment for putting the present disclosure into practice will be described with reference to the accompanying drawings. The embodiment below is an example for describing the present disclosure, and the technical scope of the invention set forth in the claims is not limited to the description below.

1. First Embodiment

1.1 Functional Configuration

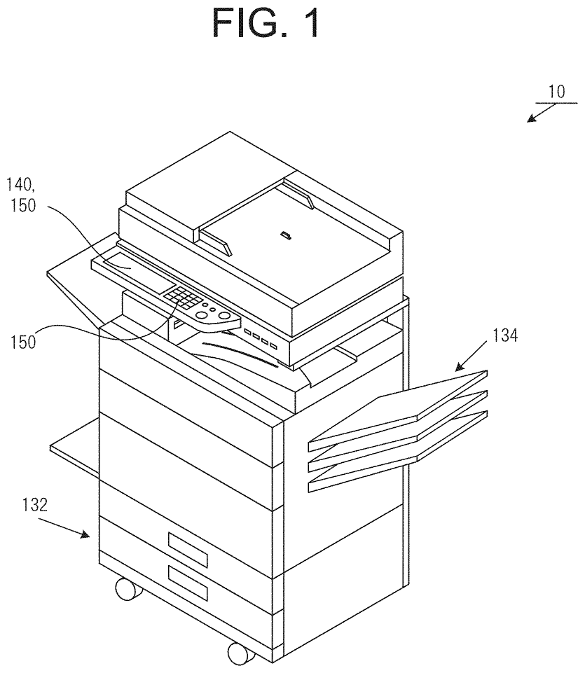

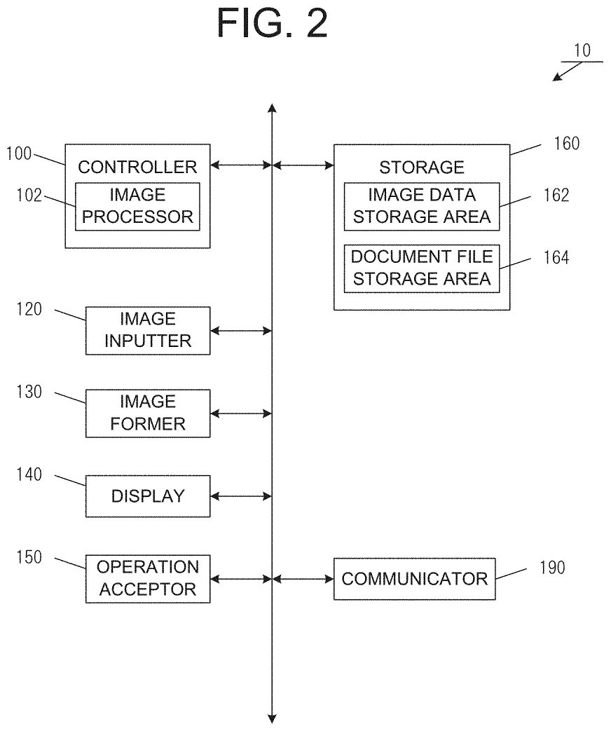

A first embodiment of the present invention will be described below with reference to the drawings. FIG. 1 is an external perspective view of an image forming device 10 according to a first embodiment, and FIG. 2 is a block diagram showing a functional configuration of the image forming device 10. The image forming device 10 is a device including, as an image forming device, an image processing device according to the present disclosure.

The image forming device 10 is a digital MFP (Multi-Function Peripheral/Printer) having functions such as copying, printing, scanning, and e-mailing. As shown in FIG. 2, the image forming device 10 includes a controller 100, an image inputter 120, an image former 130, a display 140, an operation acceptor 150, a storage 160, and a communicator 190.

The controller 100 is a functional part for controlling the image forming device 10 as a whole. The controller 100 reads out and executes various programs stored in the storage 160 thereby to execute various functions, and includes, for example, one or more computing devices (CPU (Central Processing Unit)), etc.

Further, the controller 100 executes the program stored in the storage 160 thereby to function as an image processor 102. The image processor 102 executes various image-related processes. For example, the image processor 102 executes a sharpening process and a tone converting process on an image that is read by the image inputter 120.

The image inputter 120 inputs any image data to the image forming device 10. For example, the image inputter 120 includes a scanner device or the like capable of reading an image and generating the image data. The scanner device converts the image into an electrical signal by, for example, an image sensor such as a CCD (Charge Coupled Device) and a CIS (Contact Image Sensor), and quantizes and encodes the electrical signal thereby to generate any digital data. The image inputter 120 may include an interface (terminal) for reading out the image data stored in a storage medium such as a USB (Universal Serial Bus) memory or an SD card. The image inputter 120 may also input the image data from such other devices via the communicator 190.

The image former 130 forms (prints) the image on a recording medium such as recording paper. The image former 130 includes, for example, a printing device such as a laser printer using an electrophotographic method. The image former 130, for example, feeds recording paper from a paper feed tray 132 in FIG. 1, forms the image on a surface of the recording paper, and discharges the recording paper from a paper discharge tray 134.

The display 140 displays various types of information. The display 140 includes a display device, such as an LCD (liquid crystal display), an organic EL (electro-luminescence) panel, and a micro LED (light emitting diode) display.

The operation acceptor 150 accepts an operation instruction from the user who uses the image forming device 10. The operation acceptor 150 includes input devices such as various key switches and a touch sensor that detects input by contact (touch). A method of detecting an input in the touch sensor may be any general detection method such as a resist membrane method, an infrared method, an electromagnetic induction method, and an electrostatic capacitive method. Further, the image forming device 10 may include a touch screen in which the display 140 and the operation acceptor 150 are integrally formed.

The storage 160 stores various programs and various data necessary for the operation of the image forming device 10. The storage 160 includes, for example, a storage device such as a solid state drive (SSD) as a semiconductor memory, and a hard disk drive (HDD).

The storage 160 reserves, as storage areas, an image data storage area 162 and a document file storage area 164. The image data storage area 162 stores any image data input by the image inputter 120. The document file storage area 164 stores any document file generated based on the image data.

The document file is a file generated by the image forming device 10, and is a file (content) in a format that can be processed in a device (an information terminal device such as PC (Personal Computer)) other than the image forming device 10. In the present embodiment, description will be made based on that the document file includes a tabular file (a file usable in spreadsheet software).

The communicator 190 communicates with any external device via LAN (Local Area Network) or WAN (Wide Area Network). The Communicator 190 includes, for example, a communication device such as NIC (Network Interface Card) used in a wired/wireless LAN, and a communication module.

1.2 Flow of Processes

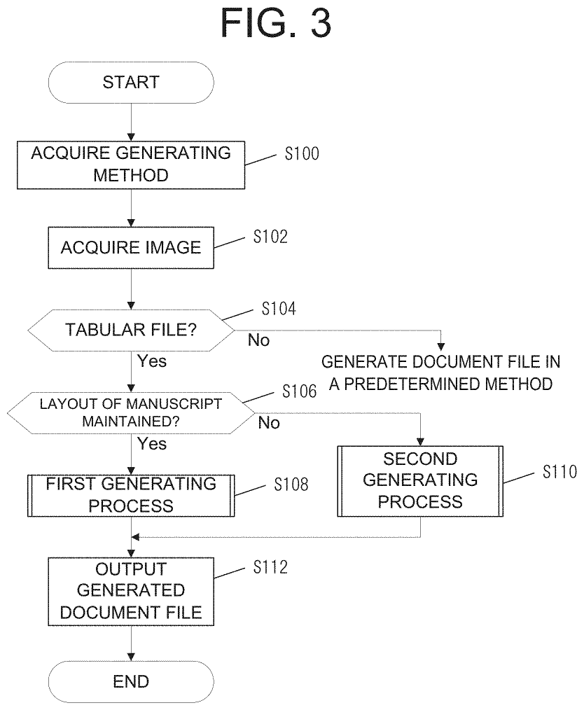

The main process executed by the controller 100 of the image forming device 10 in the present embodiment will be described referring to FIGS. 3 to 5. The processes shown in FIGS. 3 to 5 are executed, for example, by the controller 100 reading a program stored in the storage 160.

1.2.1 Main Process

Referring to FIG. 3, the main process executed by the controller 100 will be described. The main process shown in FIG. 3 is executed when the scanner function (scanner mode) is selected, which is a function to have a manuscript scanned by the scanner device constituting the image inputter 120 and to generate the document file of the manuscript.

First, the controller 100 acquires a document file generating method (step S100). For example, when detecting that the manuscript has been placed on the image inputter 120 by the user, the controller 100 displays, on the display 140, a screen for selecting the document file generating method (format selection screen). The format selection screen, as the case may be, includes, for example, a button and list for setting a document file format and details of the document file generating method. Via the format selection screen, the controller 100 acquires the document file generating method selected by the user.

In the present embodiment, the controller 100 acquires the document file format as the document file generating method. For example, the controller 100 acquires, as the document file format, formats such as an image, a PDF (Portable Document Format), a file used in software such as word processor, and a tabular file.

Here, the tabular file is a file in which a plurality of cells is placed and a document file which has layout information such as cell height and cell width. The cell height and the cell width can be set, and a character, etc. is inserted into the cell with the height and width thereof being set. The layout information may be information such as margin, text box placing position, etc. The text box in the tabular file is an area that can be placed on the cell in an overlapped manner and that can contain a character string inside. Further, the position and size of the text box can be set by the user. Further, the tabular file may be able to couple cells.

When the selected document file format is the tabular file, the controller 100 acquires the setting of the layout of the above document file. The layout of the document file refers to the placing position and placing method of any elements included in the document file, such as characters, tables, text boxes, etc., and also refers to a method of setting the row height of cells and/or the column width of cells.

In the present embodiment, as the setting of document file layout, the following two types of settings are to be selectable.

(1) Layout setting that maintains (reproduces), as much as possible, the position of placing tables and characters included in the manuscript (first setting)

(2) Layout setting in which the position of placing tables and characters is properly determined based on the image of the manuscript in order to reproduce, in a state easy for the user to edit, the tables and characters included in the manuscript, giving priority to the proper placing of the table included in the manuscript (second setting).

In the present embodiment, the first setting is also described as the setting that maintains the layout of the manuscript. The second setting is a layout setting in which, although the layout is less reproducible than the first setting, tables and characters included in the document file can be easily used or edited by the user. In the present embodiment, as the second setting, it is possible to select either the setting to extract only tables or the setting to extract tables and characters, and for the setting to extract tables and characters, it is possible to select either the setting to include characters in the cell or the setting to include characters in the text box.

That is, when, from the input image (the image of the manuscript), the tabular file is generated as a document file reproducing the above image, the user can select one of the following four layout settings.

(1) Setting to maintain the layout of the manuscript

(2) Setting to extract only tables

(3) Setting to extract tables and characters, and to include, in text boxes, characters outside the table.

(4) Setting to extract tables and characters, and to include, in the cells, characters outside the table.

Then, the controller 100 acquires the image (step S102). For example, the controller 100 executes a controlling operation to have the image inputter 120 read the placed manuscript and input the image data of the above manuscript. In the image data storage area 162, the controller 100 stores the image data input by the image inputter 120.

Then, based on the document file generating method acquired in step S100, the controller 100 determines whether or not the to-be-generated document file is in the form of the tabular file (step S104).

When determining that the document file format is in the form of the tabular file, the controller 100 selects the layout setting, and determines whether or not the selected layout setting is the setting that maintains the layout of the manuscript (the first setting) (step S104; Yes→step S106). For example, the controller 100 selects the layout setting based on the document file generating method acquired in step S100.

When the layout setting is to maintain the layout of the manuscript, the controller 100 executes the first generating method (step S106; Yes→step S108). The first generating method is to generate the document file that maintains (reproduces) the layout of the tables and characters included in the manuscript. That is, the first generating method is to generate the document file that gives priority to maintaining the layout of the tables and characters included in the manuscript. The first generating method will be described below.

Meanwhile, when the layout setting does not maintain the layout of the manuscript (being the second setting), the controller 100 executes the second generating process (step S106; No→step S110). The second generating process is to generate the document file that reproduces, in a state easy for the user to edit, the tables and characters included in the manuscript. That is, the second generating process is to generate the document file with priority given to reproducing the table included in the image. The second generating process will be described below.

In this way, based on the document file generating method acquired in step S100, the controller 100 generates, as the document file, the tabular file that is based on the setting selected from a plurality of layout settings.

Then, to the document file storage area 164 of the storage 160, the controller 100 outputs (stores) the document file generated in the first generating method or the second generating process (step S112). The controller 100 may output the document file by storing the document file in a device or place designated by the user or by sending the document file in a method designated by the user.

Note that, when determining in step S104 that the to-be-generated document file format is a format other than the tabular format, the controller 100 generates the document file in a predetermined method (step S104; No).

### 1.2.2 First Generating Method

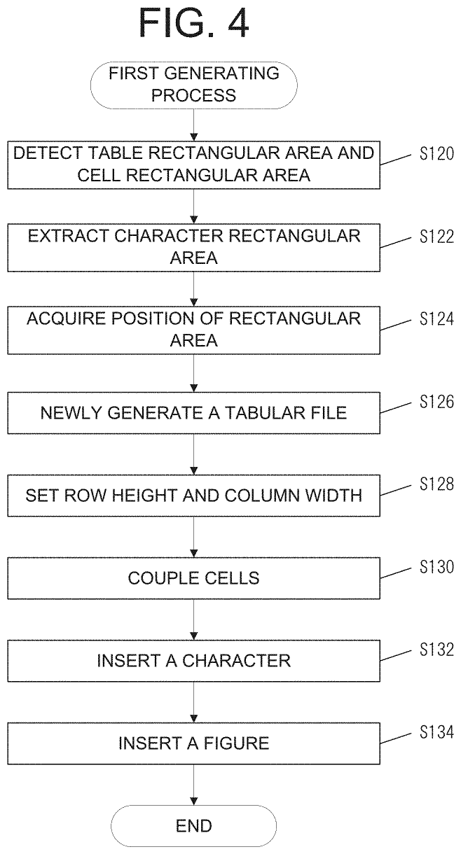

Referring to FIG. 4, the first generating method will be described. First, from the image acquired in step S102, the controller 100 detects a table rectangular area as an area that constitutes the table, and an area for each square included in the table (cell rectangular area) (step S120). For example, the controller 100 detects ruled lines placed in a grid, areas surrounded by rectangles, characters and the like placed by a predetermined placing method (e.g., right-aligned), and thereby detects cell rectangular areas. Further, the controller 100 combines adjacent cell rectangular areas, and detects, as the table rectangular area, any rectangular area circumscribing the above combined cell rectangular area.

Then, from the image acquired in step S102, the controller 100 detects a character string rectangular area (step S122). The character string rectangular area is a rectangular area composed of character strings included in an area other than the table rectangle. For example, from an area other than the table rectangular area detected in step S120, the controller 100 detects an area that constitutes a character (character area). Further, with a combination of the detected adjacent character areas as a character string area, the controller 100 detects, as the character string rectangular area, any rectangular area circumscribing the above character string area.

Then, the controller 100 acquires the positions of the rectangular areas (all pieces of information about the rectangle of the table rectangular area, the cell rectangular area, and the character string rectangular area) detected in step S120 and step S122 (step S124). For example, as the positions of the table rectangular area, the cell rectangular area, and the character string rectangular area, the controller 100 uses the coordinates of the image acquired in step S102, and acquires the coordinates that correspond to the upper left and lower right positions of the respective rectangular areas.

Then, the controller 100 newly generates a tubular file (step S126), and sets the row height and column width of the sheet based on the the rectangular area's position acquired in S124 (step S128). That is, based on the document file generating method, the controller 100 changes the cell row height and cell column width settings as information about the layout of the tabular file. In this way, the controller 100 executes the process of step S128 thereby to determine the position and size of the cells included in the document file.

In step S128; from the coordinates showing each rectangular area's upper left position acquired in step S124, the controller 100 extracts a value (x-coordinate) showing the horizontal position, and adjusts the column width so that the extracted x coordinate is positioned at the boundary of the column of the document file. For example, when, from the coordinate showing each rectangular area's upper left position, having acquired values such as 20, 50, and 120 as the values showing the horizontal positions, the controller 100 sets an A column width to a width equivalent to 20, a B column width to a width equivalent to 30, and a C column width to a width equivalent to 70. When the horizontal positions of a plurality of rectangular areas are identical, the controller 100 may treat the horizontal positions of the plurality of rectangular areas as a single value (e.g., an average value).

Similarly, from the coordinates showing each rectangular area's upper left position acquired in step S124, the controller 100 extracts a value (y-coordinate) showing the vertical position, and adjusts the row height so that the extracted y coordinate is positioned at the boundary of the row of the document file.

In this way, the controller 100 causes each rectangular area's upper left position acquired in step S124 to be the position of an upper left position of any cell included in the document file generated in step S126.

In addition, the controller 100 may further adjust the row height and column width, or add the row and the column, in view of the rectangular area's lower right position. For example, when having sequentially detected the character string rectangular areas in the vertical direction along the upper position to the lower position of the image, the controller 100 determines whether or not the difference between the lower right y-coordinate of a certain character string rectangular area and the upper left y-coordinate of the next-detected character string rectangular area exceeds a predetermined value. When the predetermined value is exceeded, the controller 100 adds a single row to between the two character string rectangular areas. When the two character string rectangular areas are spaced apart, the above process allows the controller 100 to prevent the height of the row that corresponds to one of the character string rectangular areas from becoming too large.

Then, the controller 100 couples the cells in the document file generated in step S126 (step S130). For example, the controller 100 acquires, one by one, the cell rectangular areas detected in step S120, and, from the document file, detects the cells that correspond to the upper left and lower right positions of the acquired cell rectangular area. When the cell that is in the document file and corresponds to the upper left position is different from the cell that is in the document file and corresponds to the lower right position, the cell rectangular area is composed of a plurality of cells in the document file. In this case, the controller 100 couples the cell that is in the document file and corresponds to the upper left position to the cell that is in the document file and corresponds to the lower right position into a single cell. The above process allows the controller 100 to represent a 1 cell rectangular area as a single cell in the document file.

Then, the controller 100 inserts a character into the cell in the document file generated in step S126 (step S132). For example, the controller 100 inserts the character string included in the cell rectangular area detected in step S120, into the cell that is in the document file and corresponds to the position of the cell rectangular area detected in step S120. Similarly, the controller 100 inserts the character string included in the character string rectangular area detected in step S122, into the cell that is in the document file and corresponds to the position of the character string rectangular area detected in step S122.

Then, the controller 100 detects a figure from the image acquired in step S102, and inserts the detected figure into the document file generated in step S126 (step S134).

With the above processes; in the document file, the tables and characters included in the manuscript are reproduced in the corresponding cells. The rows and columns of the document file are set based on the the rectangular area's position detected from the image of the manuscript, so the placing position (layout) of the characters and tables included in the manuscript is properly reproduced based on the image of the manuscript.

### 1.2.3 Second Generating Process

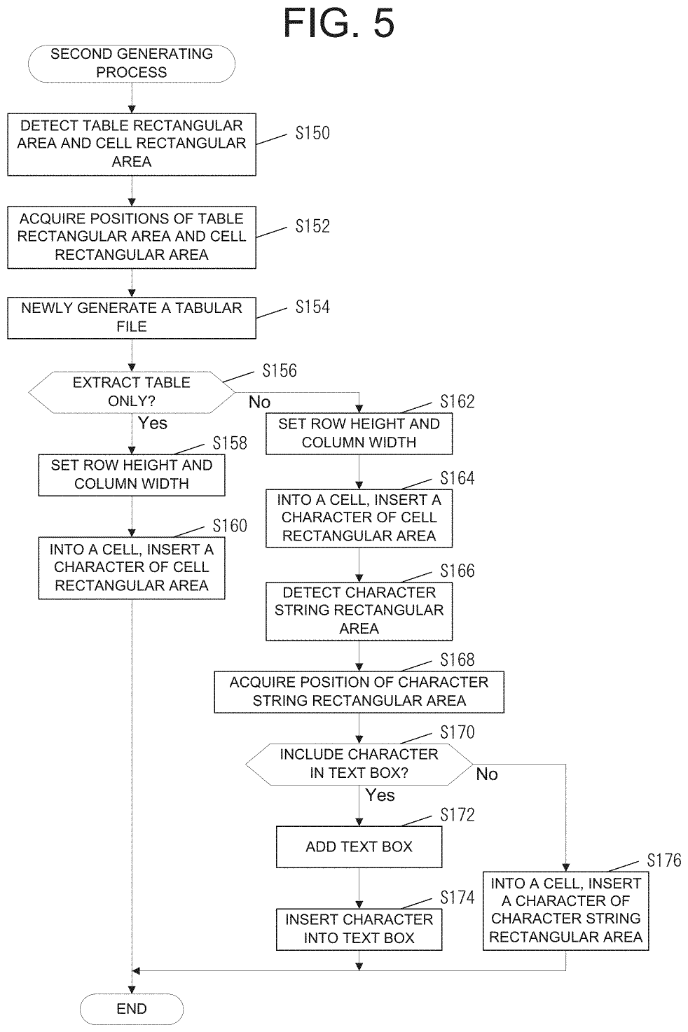

Referring to FIG. 5, the second generating process will be described. First, from the image acquired in step S102, the controller 100 detects the table rectangular area and the cell rectangular area (step S150). The process in step S150 is similar to the process in step S120 in FIG. 4.

Then, the controller 100 acquires the positions of the table rectangular area and the cell rectangular area detected in step S150 (step S152). The process in step S152 is similar to the process in step S124 in FIG. 4.

Then, the controller 100 newly generates a tubular file (step S154).

Then, the controller 100 determines whether or not the layout setting is for extracting only the tables (step S156).

Determining that the layout setting is a setting of extracting only tables, the controller 100 sets the row height and column width of the sheet included in the document file generated in step S154 (step S156; Yes→step S158). The process in step S158 is similar to the process in step S128 in FIG. 4. Here, in the second generating process, since the character string rectangular area is not detected, the column width and the row height are not set based on the character string rectangular area. That is, the column width and row height of the document file are set based on the cell rectangular area only. As a result, a single cell rectangular area is not composed of a plurality of cells in the document file.

Then, into the cell in the document file generated in step S154, the controller 100 inserts the characters included in the cell rectangular area detected in step S150 (step S160). The process in step S160 is similar to the process in step S132 in FIG. 4.

Meanwhile, determining in step S156 that the layout setting does not extract only tables, the controller 100 sets the row height and column width of the sheet included in the document file generated in step S154 (step S156; No→step S162). The process in step S162 is similar to the process in step S158; in step S162, however, the controller 100 includes extra columns and rows outside the table rectangular area as well. The number of rows and columns to be included outside the table rectangular area is properly determined by the controller 100 based on the position of the table rectangular area.

Then, the controller 100 inserts a character into the cell in the document file generated in step S154 (step S164). The process in step S164 is similar to the process in step S160.

Then, the controller 100 detects the character string rectangular area from the image acquired in step S102, and acquires the position of the above character string rectangular area (step S166→step S168). The process in step S166 is similar to the process in step S122 in FIG. 4. Further, the process in step S168 is similar to the process in step S124 in FIG. 4.

Then, the controller 100 determines whether or not the layout setting is to include the characters in the text box (step S170).

Determining that the layout setting is to place the character in the text box, the controller 100 adds a text box to the document file generated in step S154 (step S170; Yes→step S172). For example, based on the position acquired in step S168, for each character string rectangular area, the controller 100 adds, to the document file, a text box having a corresponding size.

Then, into the text box added in step S172, the controller 100 inserts the character included in the corresponding character string rectangular area (step S174).

Meanwhile, when not determining in step S170 that the layout setting is to place the character in the text box; into the cell in the document file generated in step S154, the controller 100 inserts the character included in the character string rectangular area (step S170; No→step S176). For example, based on the position acquired in step S168, the controller 100 may, for each character string rectangular area, detect the cell in a corresponding position, from the document file generated in step S154. Then, into the detected cell, the controller 100 inserts the character included in the character string rectangular area. Thus, in the cell present in the position of and adjacent to the character described in the manuscript, among the cells in the document file, the controller 100 can include the character described in the manuscript.

In the second generating process; when plural character string rectangular areas are adjacent to each other, the controller 100 may include, in a single cell, a text of a plurality of lines as configuring a text of the plurality of lines by the characters included in the plurality of character string rectangular areas.

1.3 Operation Example

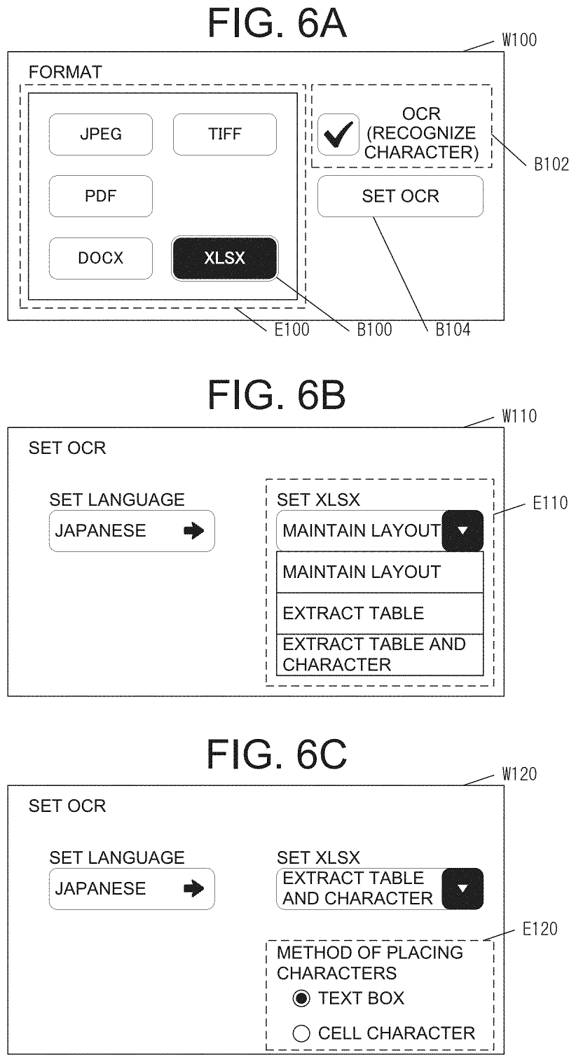

Referring to FIGS. 6 through 14, examples of the operations in the present embodiment will be described. FIG. 6A, FIG. 6B, and FIG. 6C each show a screen example of the format selection screen displayed on the display 140. A format selection screen W100 shown in FIG. 6A includes an area E100 where buttons for selecting the format of the to-be-generated document file is placed. Further, FIG. 6A shows a state in which, as the format of the to-be-generated document file, a button B100 that corresponds to the tabular file (XLSX format) is selected.

The format selection screen W100 also includes a checkbox B102 to select whether or not to execute a character recognition. When the checkbox B102 is checked, a button B104 for setting the character recognition becomes selectable.

FIG. 6B shows a detail screen W110 of a format selection screen that is displayed on the display 140 instead of the format selection screen W100 when the button B104 shown in FIG. 6A is selected. The detail screen W110 includes a list E110 to select the layout setting in the case of generating the tabular file. The list E110 includes three items, that is, “Maintain Layout,” “Extract Table,” and “Extract Table and Character.”

FIG. 6C shows a detail screen W120 in the case of selecting the “Extract Table and Character” from the list E110 shown in FIG. 6B. The detail screen W120 includes an area E120 with buttons for selecting the method of placing characters included in an area other than the table rectangular area. The area E120 includes two buttons, that is, “Text Box” to include and place, in the text box, the character included in the area other than the table rectangular area, and “Cell Character” to include and place, in the cell, the character included in the area other than the table rectangular area.

Thus, when generating the tabular file, the user, on the format selection screen, can set the button and list to the following states.

(1) State of having selected “Maintain Layout” from the list

This state corresponds to an operation where the setting to maintain the layout of the manuscript has been selected as the layout setting.

(2) State of having selected “Extract Table” from the list This state corresponds to an operation where the setting to extract only tables has been selected as the layout setting.

(3) State of having selected “Extract Table and Character” from the list, and having selected “Text Box” from the method of placing characters

This state corresponds to an operation where the setting to extract tables and characters, and to include, in the text box, the character outside the table has been selected as the layout setting.

(4) State of having selected “Extract Table and Character” from the list, and having selected “Cell Character” from the method of placing characters

This state corresponds to an operation where the setting to extract tables and characters, and to include, in the cell, the character outside the table has been selected as the layout setting.

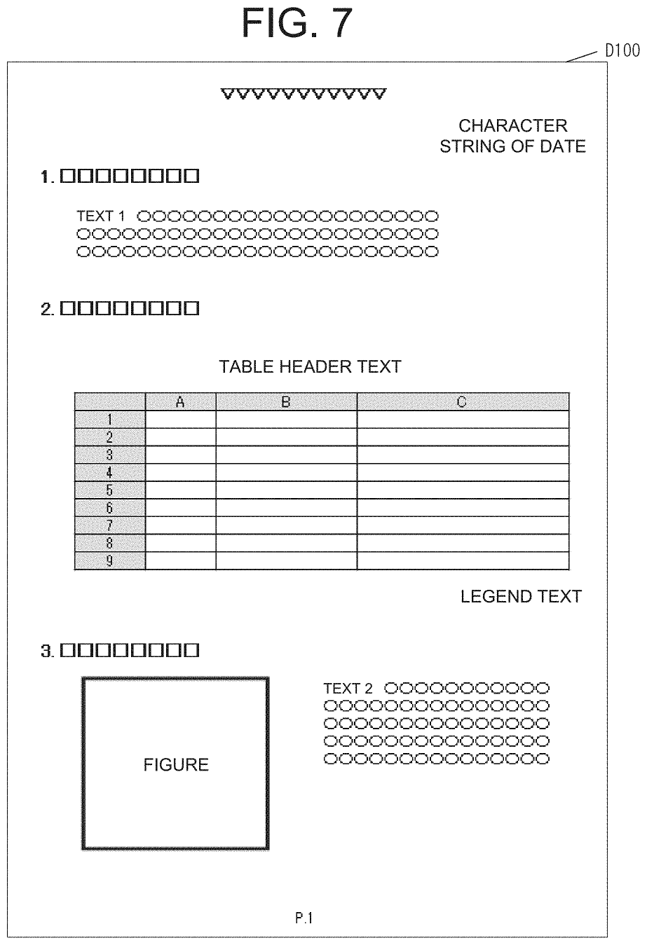

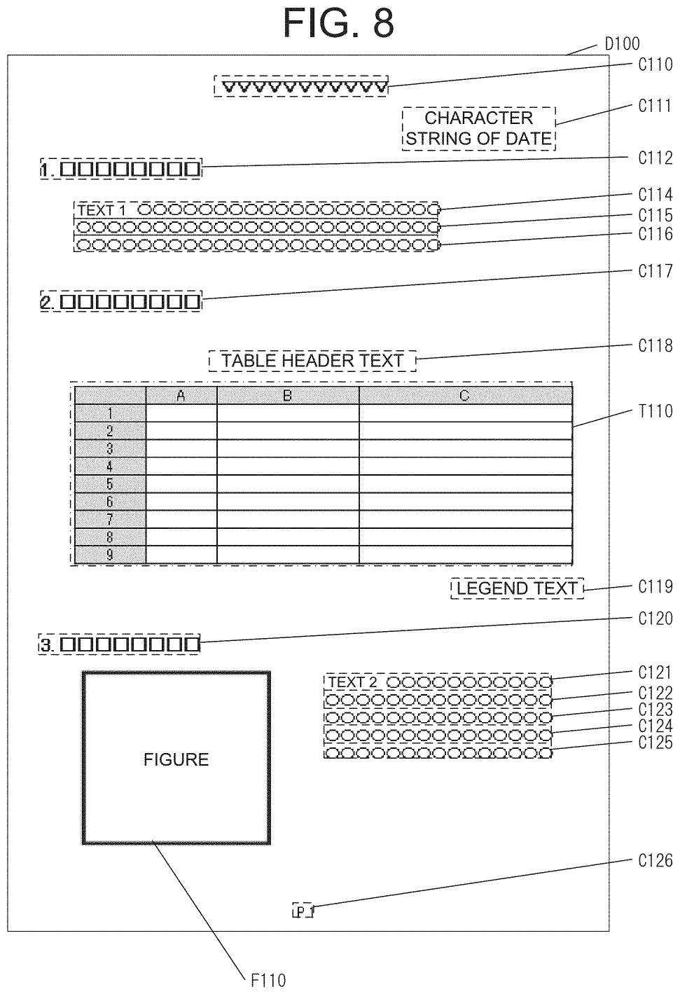

Referring to FIGS. 7 through 10, description will be made of an operation example executed when the document file is generated from the image based on the setting that maintains the layout of the manuscript. FIG. 7 shows an image D100 of the manuscript input via the image inputter 120. Further, FIG. 8 shows the table rectangular area and character string rectangular area detected from the image D100 of the manuscript.

As shown in FIG. 8, a table rectangular area T110, indicated by a single dashed line, is detected as the table rectangular area. A cell rectangular area is included inside the table rectangular area T110. As the cell rectangular area, a cell rectangular area that corresponds to 40 cells is detected, which include ten rows including a head row and rows 1 to 9, and four columns including a head column and columns A to C. Further, as the character string rectangular area, 16 areas including areas C110 to C112 and C114 to C126 indicated by dashed lines are detected. As shown in FIG. 8, the image D100 of the manuscript includes a figure F110, but the figure F110 is not detected as a rectangular area.

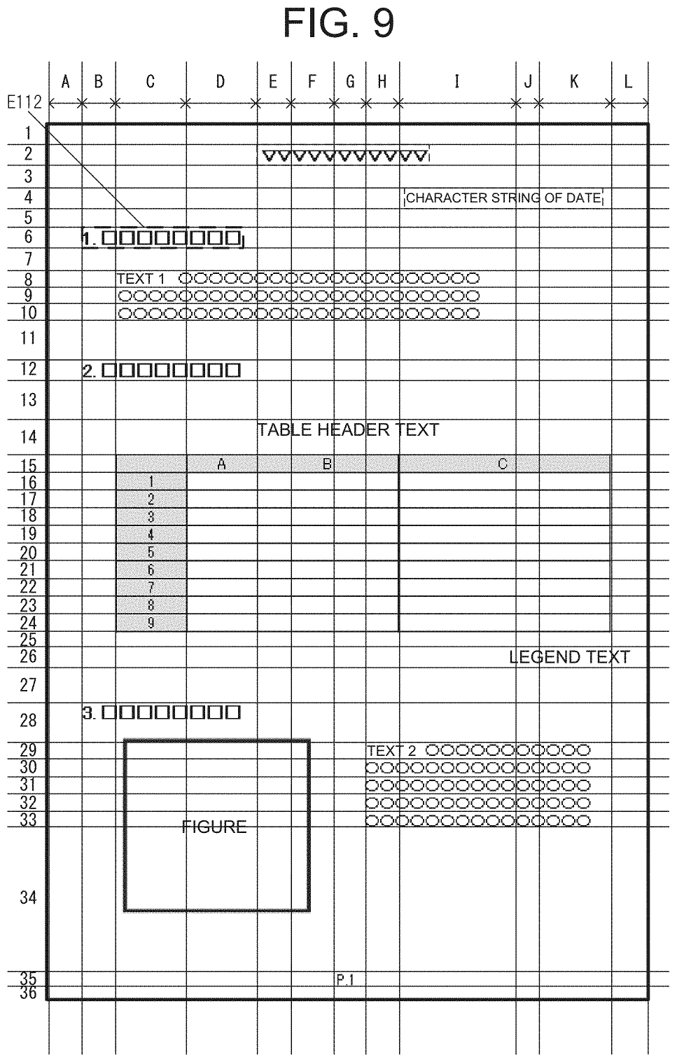

FIG. 9 shows how the column width and the row height are set based on the rectangular area detected in FIG. 8. A character string rectangular area E112 shown in FIG. 9 corresponds to the character string rectangular area C112 shown in FIG. 8.

The column width and row height of the document file are set based on the position of the detected rectangular area. For example, based on the character string rectangular area E112 shown in FIG. 9, the width of the column A of the document file is set so that the upper left position of the character string rectangular area E112 is a boundary between the column A and the column B. Similarly, the width of the column of the document file is set based on the upper left position of the rectangular area detected from the image of the manuscript. As a result, as shown in FIG. 9, the widths of the columns A through L and the heights of the rows 1 through 36 of the document file are set.

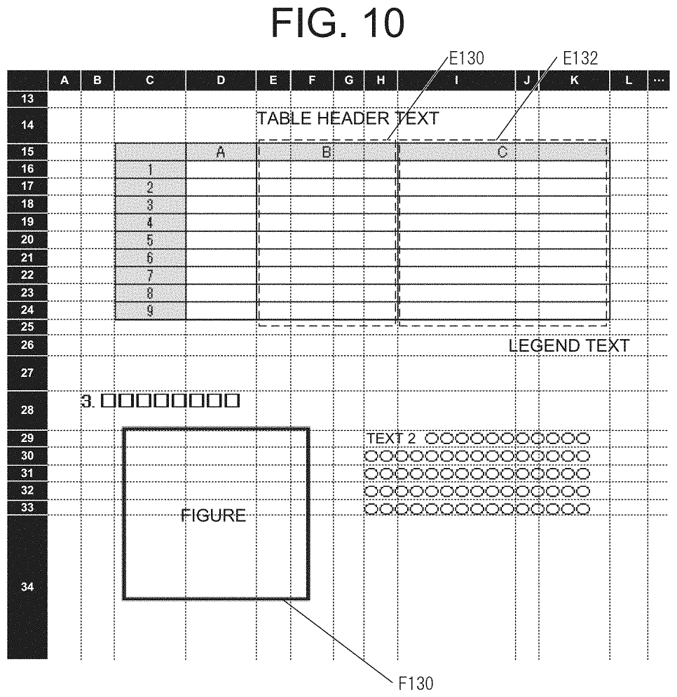

FIG. 10 shows the document file seen after the cells have been combined and the characters and the figure have been inserted. An area E130 in FIG. 10 shows an area that corresponds to the cell rectangular area in the column B, in the table rectangular area T110 shown in FIG. 8. When the column width is set as shown in FIG. 9, the area that corresponds to the cell rectangular area in the column B spans the column E through a column H in the document file. The state where the area that corresponds to the cell rectangular area spans a plurality of columns is detected by the image forming device 10 based on the difference in columns that correspond to the upper left and lower right positions of the cell rectangular area. In this case, the areas corresponding to the cell rectangular areas are coupled by the image forming device 10 so as to become a single cell in the document file. As a result, as shown in FIG. 10, the cell rectangular area of the column B in the table rectangular area T110 is reproduced in a state where columns E through H are coupled in the document file.

Similarly, of the table rectangular area T110 shown in FIG. 8, the area that corresponds to the cell rectangular area in a column C spans columns I through K in the document file. In this case, as shown in FIG. 10, the document file reproduces the columns I through K in a state of being coupled.

In the above state, the character included in the cell rectangular area is inserted into the cell; therefore, in the document file, the character included in each square of the table is included in a single cell in the document file.

Further, in FIG. 10, the figure F110 shown in FIG. 8 is inserted, as a figure F130, to a predetermined position in the document file. In this way, the document file that is based on the image of the manuscript is generated while the placing positions of tables, characters, and figures included in the manuscript are maintained.

Thus, the document file generated by the setting that maintains the layout of the manuscript maintains the layout such as the position of characters included in the manuscript. Therefore, for acquiring a tabular file that includes the content described in the manuscript, the user should have the image forming device 10 generate the document file with the setting that maintains the layout of the manuscript.

In the document file, the characters included in the manuscript are placed as characters included in cells, and further, the figures are placed. This makes it easy to modify the characters and figures. For example, after acquiring the document file, the user can edit the document file and print the edited document file.

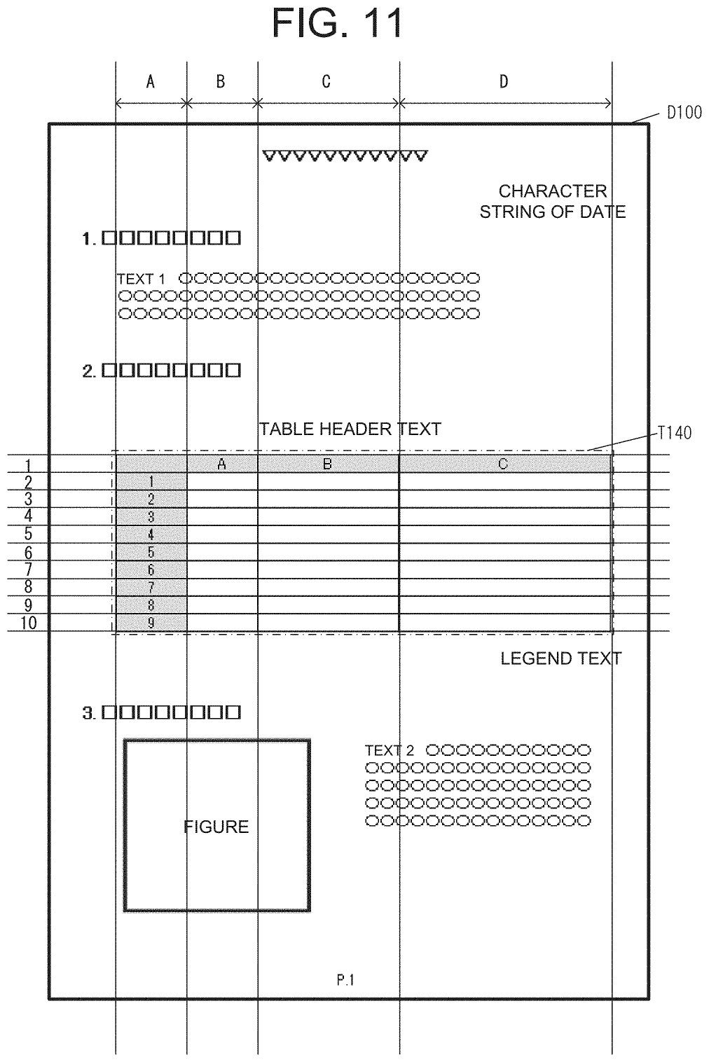

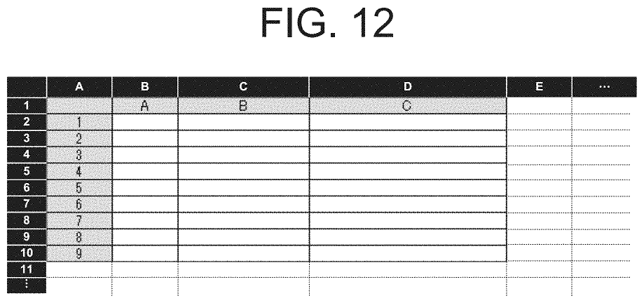

Referring to FIGS. 11 and 12, description will be made of an operation example executed when the document file is generated from the image based on the setting that extracts only tables. FIG. 11 shows a case where, from the image D100 of the manuscript, a table rectangular area T140 indicated by a single dotted line is extracted, as a table rectangular area. A cell rectangular area is included in the table rectangular area T140.

Further, based on the cell rectangular area, the column width and row height of the document file are set. When only tables are extracted, the column width and row height of the document file are set based on the position of the cell rectangular area. Therefore, the column width of the document file is set based on the widths of the four columns, that is, the head column and the columns A to C included in the table rectangular area T140. Similarly, the row height of the document file is set based on the heights of the ten rows, that is, the head row and the rows 1 to 9 included in the table rectangular area T140.

FIG. 12 shows the document file seen after the characters of the cell rectangular area have been inserted. As shown in FIG. 12, the document file is a file in which the height and width of the cell rectangular area are set and the character in the cell rectangular area is inserted, resulting in a file that reproduces only the table rectangular area T140 shown in FIG. 11.

In this way, the setting to extract only tables allows the document file to reproduce only the table included in the manuscript. Thus, the user can easily edit and process the table. Further, even when having copied the table included in the document file and having pasted the table on any other data or software, the user can easily edit the tables in the above other data or software.

Further, since the document file does not show coupled cells, the user, when copying the entire table and pasting the entire table on the other software thereby to use information on the table, can execute the pasting in a format that is easy to edit in that other software.

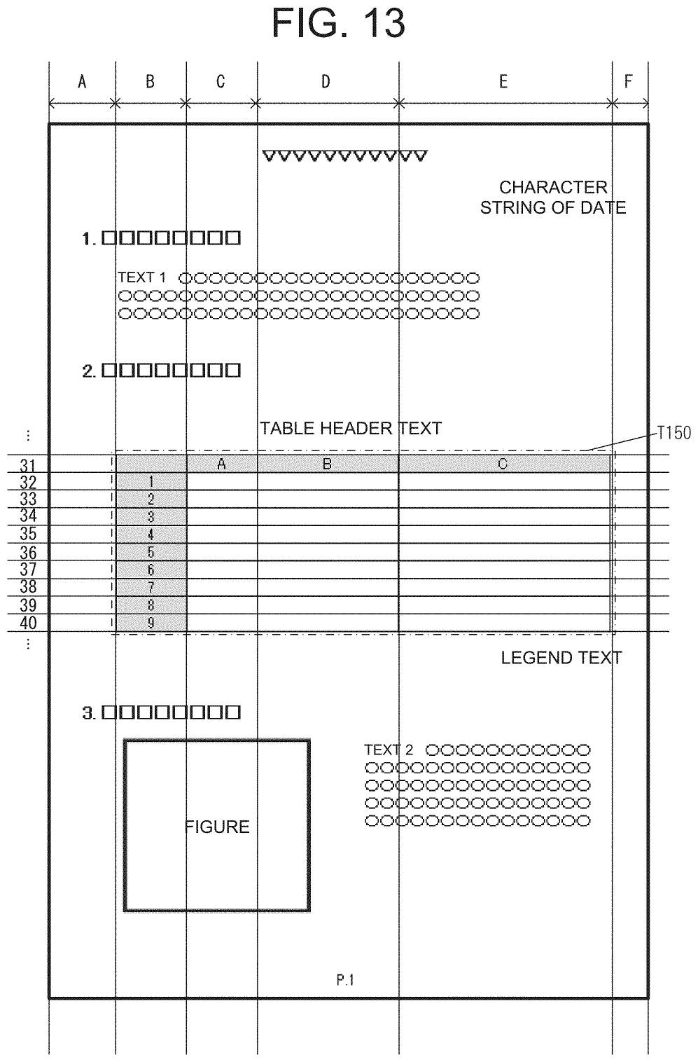

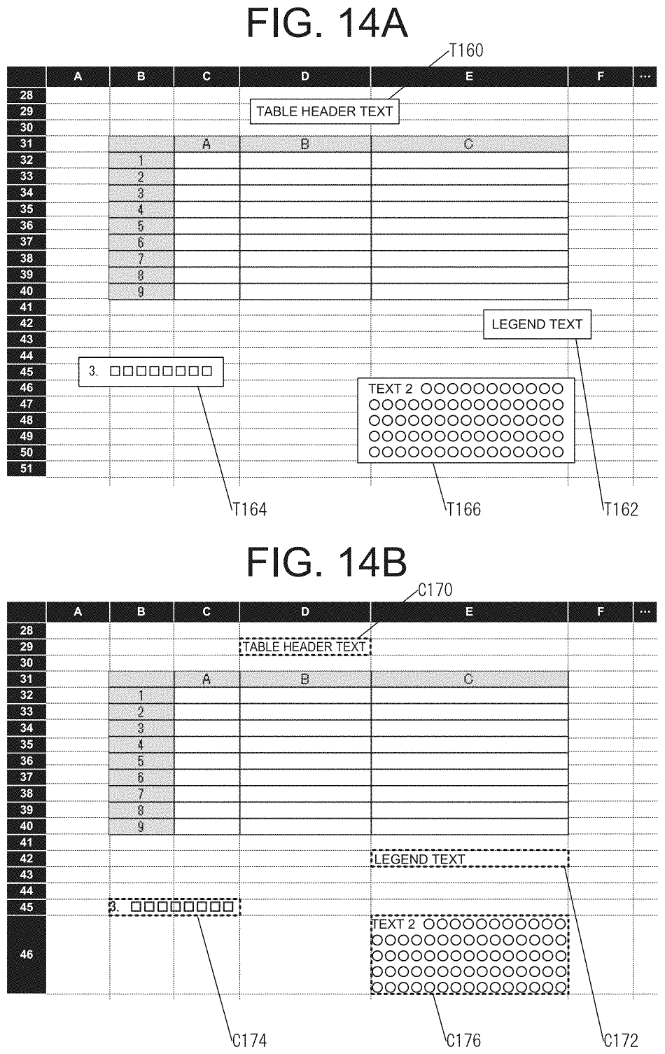

Referring to FIGS. 13 and 14, based on the setting that extracts tables and characters, description will be made of an operation example executed when the document file is generated from the image. FIG. 13 shows a case where, from the image D100 of the manuscript, a table rectangular area T150 indicated by a single dotted line is extracted, as a table rectangular area. Similar to the setting that extracts only tables, the setting that extracts tables and characters sets the column width and row height of the document file based on the position of the cell rectangular area. However, the setting that extracts tables and characters extra sets rows and columns in an outside area other than the table rectangular area.

FIG. 14A and FIG. 14B each show the document file seen after the character has been inserted. FIG. 14A shows the document file in which the character outside the table (character positioned outside the table rectangular area) is included in text box. As shown in FIG. 14A, the characters outside the table are shown in text boxes T160, T162, T164, T166.

FIG. 14B shows the document file in which the characters outside the table are included in cells. As shown in FIG. 14B, the characters outside the table are included in cells C160, C162, C164, C166. The cells including the characters outside the table are determined based on the position of the character string rectangular area detected from the image of the manuscript. Therefore, the position of the character shown in the image of the manuscript, as the case may be, differs from the position of the character shown in the document file.

Thus, for the document file that is set to extract tables and characters, the user can easily edit and process tables, copy and paste tables for use in any other documents, and do any other operation, in the same way as for the document file that is set to extract only tables. Further, from the document file, user can acquire information about the characters listed around the table, such as the table's title and legend, so that the user can easily use the characters included in the manuscript.

Further, the document file by the setting to include, in the cells, the characters outside the table is reproduced with the characters outside the table included in a predetermined cell based on the layout in the manuscript. In this way, in the document file, the column width and row height are set based on the cell rectangular area, and the characters outside the table are included in the cells at the proper position; therefore, no coupled cells appear in the document file. Further, a text of a plurality of lines is also embedded in a single cell. Therefore, in the case of use in any other software, the user can simply copy the entirety of the document file and paste the entirety of the document file as is on the other software. In this case, in the other software, the tables and characters included in the document file are pasted in an easy-to-edit format, allowing the user to easily use and edit, in the other software, the tables and characters included in the document file.

The above describes the case in which the image processing device according to the present disclosure is configured as the image forming device, but the image processing device may be configured by any other device. For example, the image processing device according to the present disclosure may be realized as an image reading device such as a scanner.

Further, the image processing device according to the present disclosure may also be realized as software that executes the processes described in FIGS. 3 through 5. In this case, the software is executed in a predetermined information processing device (terminal device such as a personal computer (PC), or server device). The server device may be composed of a virtual server realized on an arbitrary information processing device. In this case, the device that executes the software acquires, in step S102, the image from the image file, etc. designated by the user. Further, in step S112, the device that executes the software stores the document file in a place designated by the user, and sends the document file by a method designated by the user.

Even in a state other than the one in the description above, the order of the steps may be changed or part of the steps may be omitted to the extent of no contradiction. For example, the controller 100 may acquire the generation method after acquiring the image. After detecting the table rectangular area from the manuscript, the controller 100 may execute the remaining processes of the first generating method and second processing method, depending on the document file generating method. Further, the configuration of each device may be changed. For example, each device may be composed of a chip (SoC; System-on-a-chip) that integrates the controller and the communicator.

In this way, the image forming device of the present disclosure can generate the document file based on one of a plurality of layout settings.

Thus, the user can have the image forming device generate the document file that accords to the user's usage.

2. Second Embodiment

Next, a second embodiment will be described. Compared to the first embodiment, the second embodiment is an embodiment that has modified the screen for selecting the setting of document file layout.

In the first embodiment, the description has been made that, as the format selection screen, the screen for selecting the setting of document file layout is displayed. The present embodiment displays, as the format selection screen, a screen that allows the user to select the intended use of the document file.

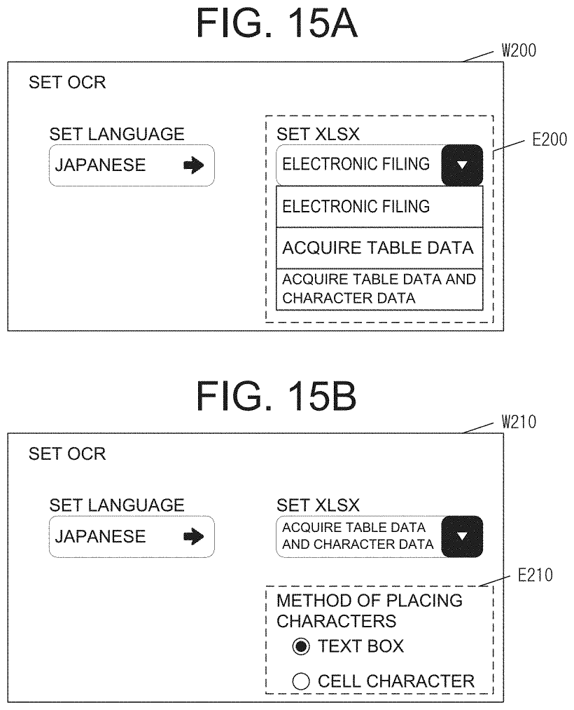

Referring to FIG. 15, description will be made of the format selection screen in the present embodiment. FIG. 15A shows a detail screen W200 of the format selection screen.

The detail screen W200 includes a list E200 for selecting the intended use in the case of generating the tabular file. The list E200 includes three items: “Electronic Filing,” “Acquire Table Data,” and “Acquire Table Data and Character Data”.

In the following manner, the above three items correspond to the items of the list E110 of FIG. 6B in the first embodiment.

(1) “Electronic Filing” corresponds to “Maintain Layout” in the list E110.

(2) “Acquire Table data” corresponds to “Extract Table” in the list E110.

(3) “Acquire Table Data and Character Data” corresponds to “Extract Table and Character” in the list E110.

Further, FIG. 15B shows a detail screen W210 seen when “Acquire Table Data and Character Data” is selected from the list E200 shown in FIG. 15A. The detail screen W210 includes an area E210 where a button for selecting the method of placing characters included in the area other than the table rectangular area is placed. The area E210 includes two buttons, that is, “Text Box” to include and place, in the text box, characters included in the area other than the table rectangular area, and “Cell Character” to include and place, in the cell, characters included in the area other than the table rectangular area.

The format selection screen shown in FIG. 15 allows the user, when generating the tabular file, to set, on the format selection screen, the buttons and lists to the following states.

(1) State of having selected “Electronic Filing” from the list

This state corresponds to an operation where, as the setting of document file layout, the setting to maintain the layout of the manuscript has been selected.

(2) State of having selected “Acquire Table Data” from the list This state corresponds to an operation where, as the setting of document file layout, the setting to extract only tables has been selected.

(3) State of having selected “Acquire Table Data and Character Data” from the list, and having selected “Text Box” from the method of placing characters

This state corresponds to an operation where, as the setting of document file layout, a setting of extracting tables and characters and including, in the text box, characters outside the table has been selected.

(4) State of having selected “Acquire Table Data and Character Data” from the list, and having selected “Cell Character” from the method of placing characters

This state corresponds to an operation where, as the setting of document file layout, the setting of extracting tables and characters, and including, in the cells, characters outside the table has been selected.

In step S100 of the main process shown in FIG. 3, the controller 100 displays the format selection screen shown in FIG. 15, and, based on the layout setting selected by the user, executes the first generating process or the second generating process.

Thus, similar to the first embodiment, the format selection screen in the present embodiment as well allows the user to select, as the layout setting, one of the four layout settings. The present embodiment also allows the user to easily select the setting of document file layout from the intended use.

3. Third Embodiment

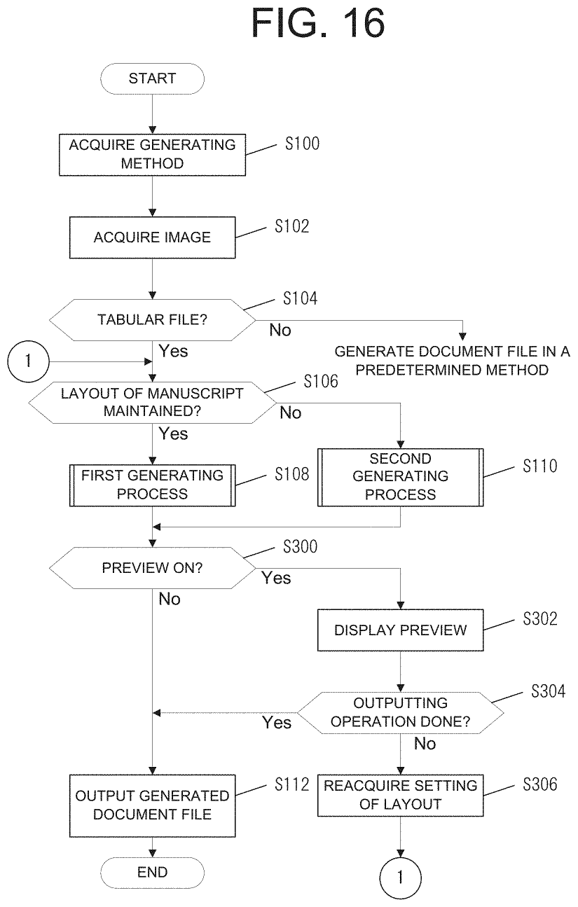

Next, a third embodiment will be described. The third embodiment is an embodiment that displays a preview of the generated document file. The present embodiment replaces FIG. 3 in the first embodiment with FIG. 16. Further, the same process is indicated by the same symbol and description thereof is omitted.

Referring to FIG. 16, the main process executed by the controller 100 will be described. After generating the document file by executing the process in step S106 or step S108, the controller 100 of the present embodiment determines whether or not the preview is ON (step S300). The preview being ON means that the function to display the preview of the document file on the display 140 is enabled before outputting of the generated document file. The preview being ON or OFF, for example, may be settable by the user or by an administrator of the image forming device 10, or may be preliminarily stored, as a value, in the image forming device 10.

When the preview is ON, the controller 100 displays, on the display 140, the preview of the document file generated in step S106 or step S108 (step S300; Yes→step (S302). Further, the controller 100 determines whether or not an operation to output the document file with the preview displayed has been executed by the user (step S304). The operation to output the document file includes, for example, an operation to select a check button displayed on the display 140 or an operation to press a hardware key showing a decision.

Determining, in step S304, that the operation to output the document file has been executed, the controller 100 outputs the document file (step S304; Yes→step S112).

Meanwhile, determining, in step S304, that the operation to output the document file has failed to be executed, the controller 100 reacquires the setting of document file layout (step S304; No→step S306). Failing to execute the operation to output the document file includes, for example, an operation to select a button other than the check button displayed on the display 140 or an operation to press a key other than the hardware key showing the decision. In this case, the controller 100 displays the format selection screen on the display 140, and, based on the user's operation, reacquires the setting of document file layout. Further, the controller 100, by returning to step S106, generates the document file based on the reacquired layout setting.

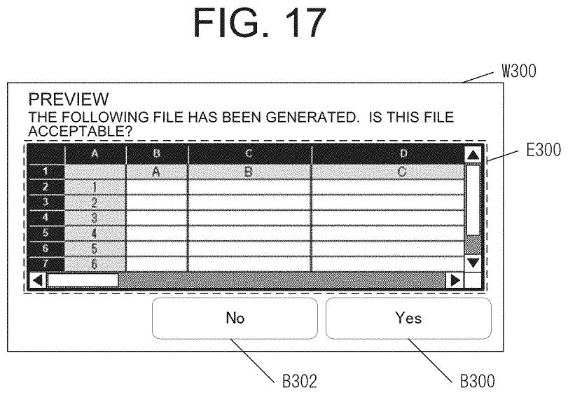

Referring to FIG. 17, an operation example according to the present embodiment will be described. FIG. 17 shows a display screen W300 displaying the preview of the generated document file. The display screen W300 includes an area E300 displaying the preview of the generated document file, and a button B300 and a button B302. The button B300 shows that the document file with the preview displayed will be output. The button B302 shows that the document file with the preview displayed will not be output and that the setting of document file layout will be designated.

After checking the preview of the document file displayed in the area E300, the user, by selecting the button B300 or the button B302, can decide whether or not to output the above document file.

Thus, according to the present embodiment; when, in the generated document file, the character or the like is not placed by the intended method, the user can easily have the image forming device change and regenerate the setting of the layout of the document file.

4. Modified Example

The present invention is not limited to each of the above embodiments, and various modifications can be made. That is, the technical scope of the present invention also includes an embodiment acquired by combining technical measures properly changed in the range not departing from the gist of the present invention.

Further, although some part of the above embodiments is described separately for convenience of description, it is needless to say that the above part may be combined and executed within the technically allowable range. For example, the second embodiment and the third embodiment may be combined. In this case, the user can specify the setting of document file layout based on the intended use, and can also check the preview of the generated document file.

Further, the program operated on each device in the embodiment is a program that controls the CPU or the like (program that causes the computer to function) so as to realize the function according to the above embodiments. The information handled by these devices is temporarily stored in a temporary storage device (e.g., RAM) at the time of processing the information, and then is stored in various storage devices such as a read only memory (ROM) and an HDD, and, as needed, is read out, corrected, and written by the CPU.

Here, a recording medium that stores the program may be any of a semiconductor medium (e.g., a ROM and a non-volatile memory card), an optical recording medium/magneto-optical recording medium (e.g., a digital versatile disc (DVD), a magneto optical disc (MO), a Mini Disc (MD), a compact disc (CD), and a Blu-ray Disc (BD) (registered trademark)), a magnetic recording medium (e.g., a magnetic tape and a flexible disk), etc. Further, executing the loaded program realizes the function of the above embodiments; however, there also may be a case where processing in collaboration with the operating system or any other application program based on the instruction of the loaded program realizes the function of an aspect of the present invention.

For market distribution, the program may be stored and distributed in a portable recording medium, or be transferred to a server computer connected via a network such as the Internet. In this case, it is needless to say that the present invention also includes a storage device of the server computer.

What is claimed is:

5

1. An image processing device, comprising:
an image inputter that inputs an image;
a selector that selects a setting of a layout; and
a generator that, based on the setting of the layout, generates, from the image, a document file having information about the layout.

2. The image processing device according to claim 1, further comprising:
a detector that detects any rectangular area from the image, wherein
when the selector selects a first setting, the generator generates the document file of the layout set based on all of the rectangular areas included in the image, and
when the selector selects a second setting, the generator generates the document file of the layout set based on a table rectangular area of the rectangular areas included in the image.

3. The image processing device according to claim 2, wherein the document file is a tabular file in which a plurality of cells is placed, and the setting of the layout includes a setting of row height of the cells and/or column width of the cells.

4. The image processing device according to claim 3, wherein when the selector selects the first setting, the generator generates the document file that maintains the layout of the image, and
when the selector selects the second setting, the generator generates the document file that maintains a placement of the cells that correspond to the table rectangular area.

5. The image processing device according to claim 1, further comprising: a display that displays a preview of the document file generated by the generator.

6. An image processing method, comprising:
inputting an image;
selecting a setting of a layout; and
based on the setting of the layout, generating, from the image, a document file having information about the layout.

7. A non-transitory computer readable medium that records a program to cause a computer to realize functions that comprise:
inputting an image;
selecting a setting of a layout; and
based on the setting of the layout, generating, from the image, a document file having information about the layout.
